(19) United States
(12) Patent Application Publication
(10) Pub. No.: US 2009/0106985 A1
(43) Pub. Date: Apr. 30, 2009

(54) HAND-HELD IMPLEMENT FOR EDGE-TRIMMING SUBSTRATE-MOUNTED LAMINATES

(76) Inventor: Lamoyne W. Durham, Saline, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/258,963

(22) Filed: Oct. 27, 2008

Related U.S. Application Data
(63) Continuation-in-part of application No. 11/454,994, filed on Jun. 16, 2006.

(51) Int. Cl. B26D 1/04; B26B 29/06; B26D 5/10; B26D 7/01

(52) U.S. Cl. 30/280; 30/273; 30/275.4; 30/282

(57) ABSTRACT

A hand-held implement for trimming mounted photographs, posters, and other laminates includes a handle, an edge guide connected to the handle defining a side surface for traveling against the peripheral edge of the substrate, and an upper guide connected to the handle defining a lower surface for traveling against the exposed front surface of the laminate. A blade, mounted on the upper guide, has a cutting edge extending below the lower surface of the upper guide and immediately adjacent the side surface of the first guide. When the side surface is stabilized against the peripheral edge of the substrate and pushed forward, the blade produces an edge perfectly matched to the edge of the laminate and an aesthetically pleasing appearance.

### REFERENCE TO RELATED APPLICATION

This application is a continuation-in-part of U.S. patent application Ser. No. 11/454,994, filed Jun. 16, 2006, the entire content of which is incorporated herein by reference.

### FIELD OF THE INVENTION

This invention relates generally to edge trimming and, in particular, to a hand-held implement for trimming photographs and other materials mounted to substrates, backer boards, and the like.

### BACKGROUND OF THE INVENTION

It is common practice to mount relatively thin sheet material such as photographs, posters, and other graphical and printed matter to thicker or more rigid substrates. For example, photographs are often displayed by mounting them to foam core or Gator boards, which foregoes the need for more expensive framing.

In mounting such materials onto the substrates, it is common practice to use a substrate which is at least slightly smaller than the periphery of the material to be mounted, since registration of a material to be mounted on a substrate of the same size is nearly impossible, particularly when strong, permanent or unforgiving adhesive techniques are used. By using a substrate which is at least slightly smaller in peripheral area than the material to be mounted, the material may be trimmed after mounting, to create a clean edge coextensive with the outline of the substrate.

Unfortunately, it is not always easy to trim a laminate of this type after it has been mounted. Generally the edge of the substrate is used as a guide, and whether a knife or blade is used from the front, or from the back, a straight visually pleasing line is difficult to achieve in practice. If approached from the front, there is no way to see what is happening during the trimming process, and the slightest waviness in the edge is immediately apparent to a critical observer. When cutting from the back, it is impossible to use a roller, since it would have to be butted up against the edge of the substrate, leaving little or no room for the blade. Accordingly, an implement for carrying out such processes would be welcome by those engaged in graphic arts and other fields of endeavor.

### SUMMARY OF THE INVENTION

This invention improves the process of trimming excess laminate extending beyond the peripheral edge of the substrate by providing a hand-held implement having a handle, an edge guide defining a side surface for traveling against the peripheral edge of the substrate, and an upper guide defining a lower surface for traveling against the exposed front surface of the laminate. A blade, mounted on the upper guide, has a cutting tip extending below the lower surface of the upper guide and immediately adjacent the side surface of the first guide. When the side surface is stabilized against the peripheral edge of the substrate and pushed forward, the blade produces an edge perfectly matched to the edge of the laminate and an aesthetically pleasing appearance.

In the preferred embodiment, the tip of the blade is spaced apart from the side surface of the first guide by a distance of two millimeters or less. The side surface includes a leading edge allowing the first guide to travel against the peripheral edge of the substrate before the blade contacts a laminate to be trimmed.

The side surface further includes a trailing edge allowing the first guide to continue traveling against the peripheral edge of the substrate after the blade trims the mounted laminate. The lower surface of the upper guide also includes leading and trailing portions.

In the preferred embodiment, the edge guide includes an upper surface, and the lower surface of the upper guide is spaced apart from the upper surface of the edge guide by a gap to receive laminate to be trimmed. The gap preferably terminates in an upward ramp on the upper surface of the edge guide. In the preferred embodiment, the lower surface of the upper guide also includes an aperture between the cutting tip and the back end of the tool to ease operation. To minimize marling or scoring of the laminate and to further ease operation, the side surface and the lower surface define an angle greater than ninety degrees. A blade holder enables the blade to be replaceable, and a mechanism may be provided for adjusting the proximity of the blade to the edge guide.

### BRIEF DESCRIPTION OF THE DRAWINGS

FIG. 1 is an oblique drawing of an embodiment of the invention, seen from above;

FIG. 2 is a side-view drawing showing the way in which the various guides interact in conjunction with the handle as it is moved forward to cut a laminate mounted to a substrate;

FIG. 3 is an oblique drawing of one embodiment, seen slightly from below, showing the knife edge used for trimming purposes;

FIG. 4 is a drawing which shows the way in which the embodiment of FIGS. 1-3 is used to trim a photograph or other laminate, with the blade cover removed to show the blade;

FIG. 5 is a drawing of the clip used to hold the blade, held in position by the blade cover;

FIG. 6 is a perspective view of a preferred embodiment of the invention;

FIG. 7 is a bottom view of the embodiment of FIG. 6 seen from a first perspective;

FIG. 8 is a bottom view of the embodiment of FIG. 6 seen from a different perspective;

FIG. 9 is a side view of the embodiment of FIG. 6 showing how an aperture and ramp cooperate to ease trimming; and

FIG. 10 is a back view of the preferred embodiment depicting the use of an angle greater than 90 degrees between the top and edge guides.

### DETAILED DESCRIPTION OF THE INVENTION

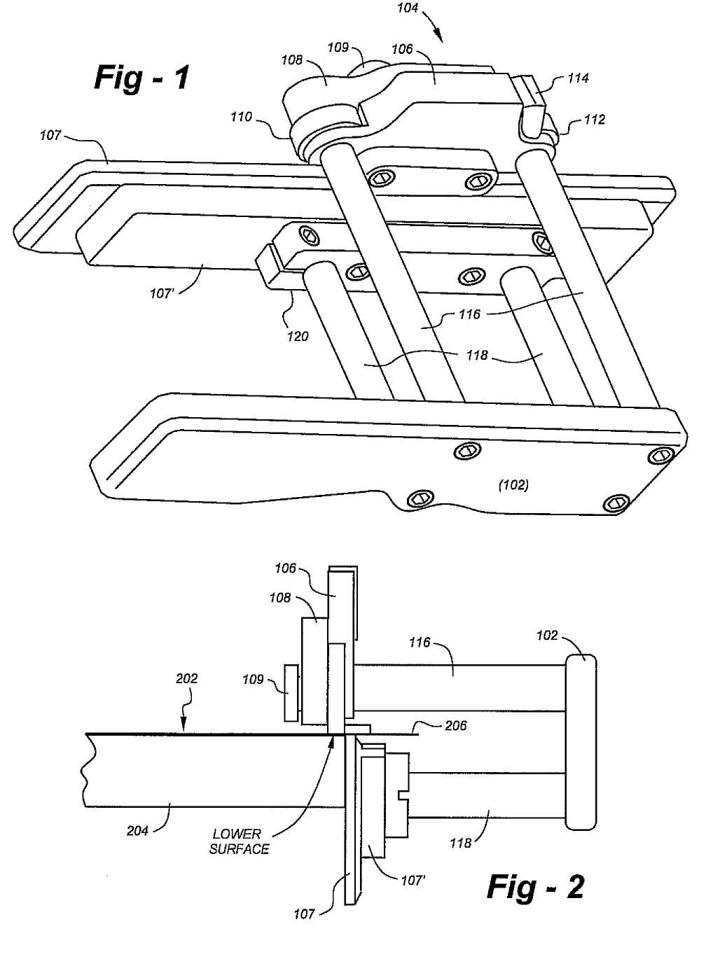

Turning now to the figures, FIG. 1 is an oblique drawing of an embodiment of the invention. The implement includes a handle 102, an upper guide 104 and an edge guide 107. These guides are rigidly connected to the handle through arms 116, 118. In this embodiment, the arms 116, 118 space the handle 102 apart from the guides by a distance of an inch or more, to facilitate the trimming of laminated materials with edge selvedges on the order of up to a few inches.

The upper guide 104 is comprised of a roller support 106, which carries rollers 110, 112. The bottom surfaces of the rollers define a lower surface configured for traveling against the exposed front surface of the laminate as it is being trimmed. Note that instead of rollers, a surface could be used to facilitate sliding engagement. The upper guide 104 further includes a blade cover 108 held against the roller support with a knob 109 to expose a blade held by blade clip 114 as shown in FIG. 4. The edge guide 106 is mounted against an edge guide support 108, which includes a rod clamping assembly 120 holding a lower set of rods 118.

In terms of materials, any suitable durable or rigid material may be used. In the preferred embodiments, the implement is constructed mostly of machined metal, aluminum in particular, though rollers 110, 112 and edge guide 107 are preferably constructed from a more slippery material such as nylon, Teflon®, or the like. Note that in place of rods 116, 118, bars of material may instead be used, which would preferably be transparent for visualization purposes. Rods 116, 118 are preferred, however, since they still allow for a great degree of visualization while providing a very rigid structure overall. Edge guide 107 is elongated to give the user a few inches of stabilized sliding against the edge of the substrate before and after the mounted laminate is trimmed.

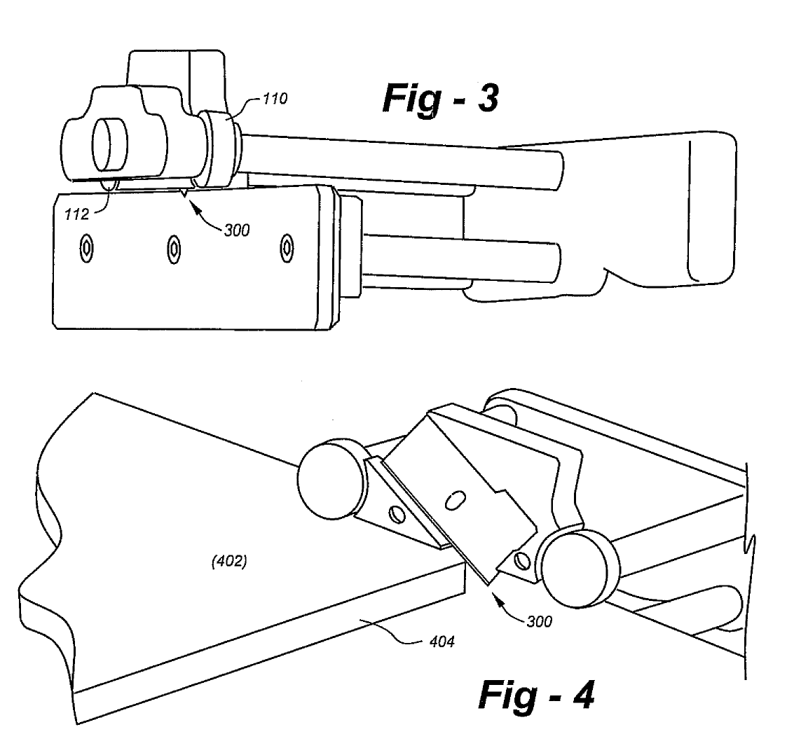

FIG. 2 is a side view drawing showing the way in which the various guides interact in conjunction with the handle as it is moved forward to cut a laminate 202 mounted to a substrate 204. The trimmed laminate is shown at 206. FIG. 3 is an oblique view seen from the underside, showing the tip of blade 300. Note that the tip 300 extends slightly below the plane defined by rollers 110, 112, while being immediately adjacent the surface of the edge guide 106.

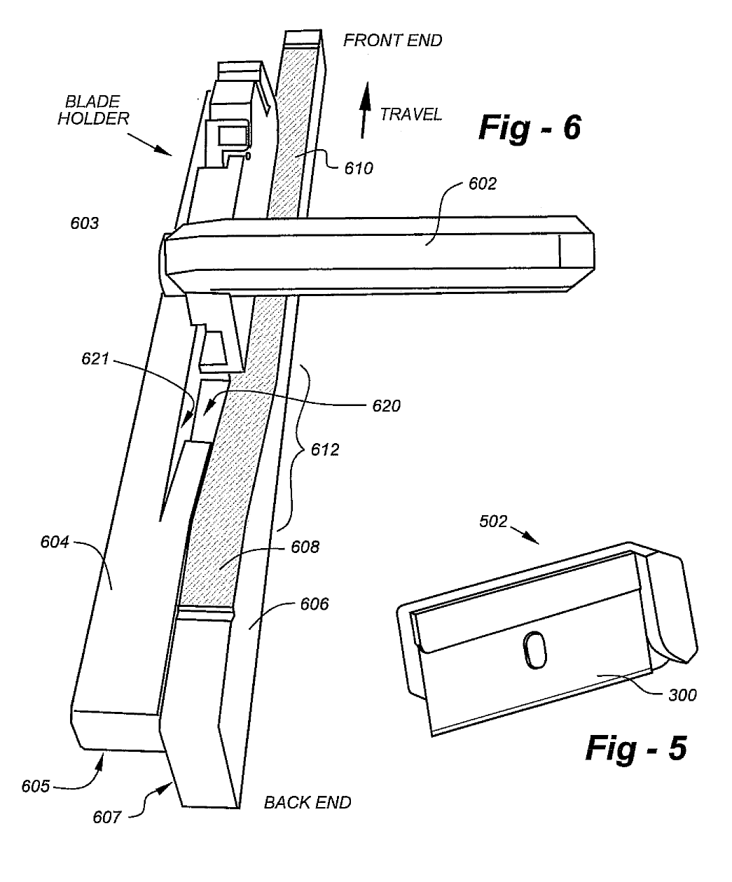

FIG. 4 is a drawing with the blade cover 108 removed, showing the blade 300 beginning to trim a laminate 402 mounted to substrate 404. FIG. 5 is a drawing of the clip 502 used to hold the blade 300, held in position by the blade cover 104. The use of the clip in conjunction with the blade cover allows for the quick interchange of blades with perfect or near-perfect registration during blade interchange. Although in this and other embodiments a single-edge-injector type blade is used due to its low cost, other clips and blades may be accommodated, including X-Acto® blades, Dexter® blades, and so forth.

FIG. 6 is a perspective view of a preferred embodiment of the invention. In this configuration, upper guide 604 is coupled to edge guide 606, and handle 602 is coupled directly to the assembled guides, thereby forgoing the need for rods 116, 118 in the previously described embodiment. Handle 602 is optionally attached using fastener 603 to reduce size for storage and shipping. The blade holder is similar if not identical to the holder previously described, using, for example, clip 614 for quick removal and changing.

The edge guide 606 has a side surface 607 for traveling against the peripheral edge of the substrate, and the upper guide 604 includes a lower surface 605 for traveling against the exposed front surface of the laminate. In this embodiment, the edge guide 606 further includes an upper surface 608 having a ramped portion 612, and upper guide 604 includes aperture 620, both of which are explained in further detail below.

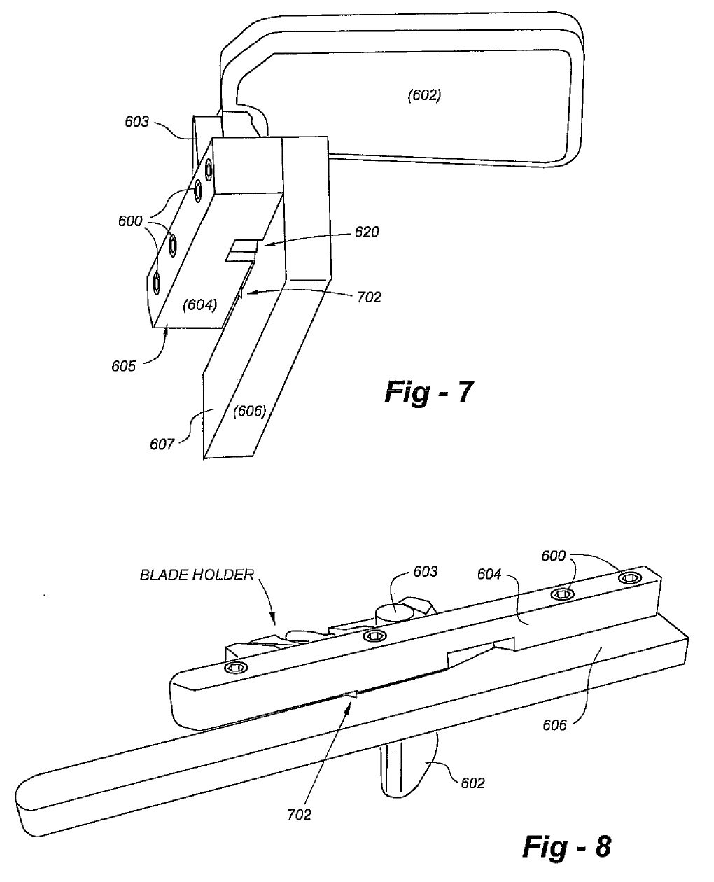

FIG. 7 is a bottom view of the embodiment of FIG. 6 seen from a first perspective, and FIG. 8 is a bottom view of the embodiment of FIG. 6 seen from a different perspective. Upper guide 604 is fastened to edge guide 606 with fasteners 600. As with the previous embodiment, the tip 702 of blade 700 is immediately adjacent side surface 607 of edge guide 606. In this and other embodiments, “immediately adjacent” means as close as possible to side surface 607 while still allowing for effective cutting of the laminate. Spacings of a few millimeters are possible. A preferred spacing is two millimeters or less, most preferably one millimeter or less.

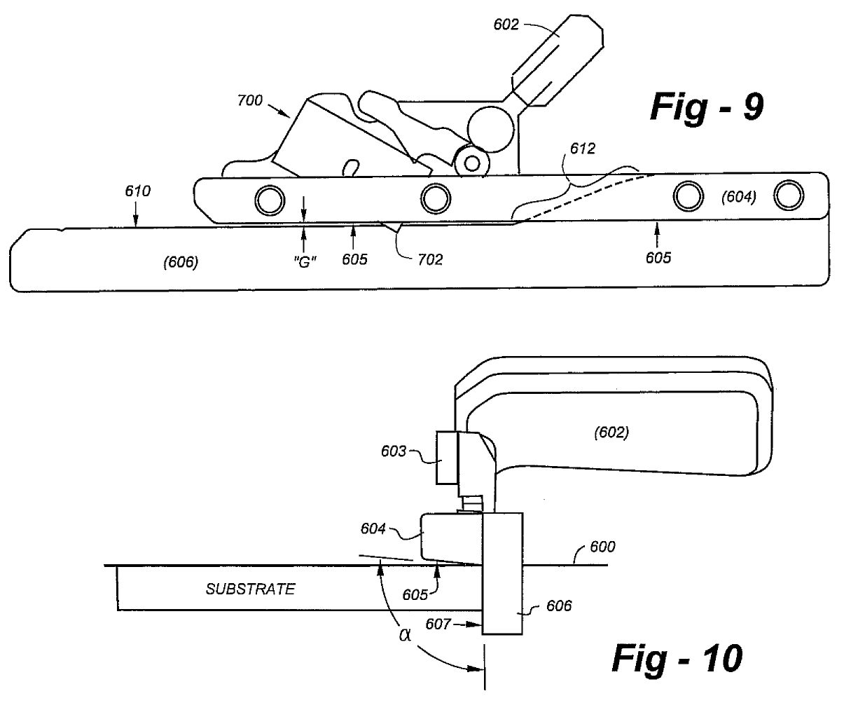

FIG. 9 is a side view of the embodiment of FIG. 6 showing how the a portion of the upper surface 610 is spaced apart from the lower surface 605 of the edge guide by a distance “G,” enabling laminate to be cut to extend therethrough. Gap G is sufficiently large to accommodate laminates such as photographs, posters, etc. As such, gaps on the order of 1-5 mm should be acceptable for this purpose.

FIGS. 6, 7 and 9 best explain how the aperture 620 and ramp 612 ease the operation of the implement and assist in the removal of laminate being trimmed. As blade tip 702 cuts through the laminate, the trimmed-off portion rides against the upper surface 610 of edge guide 606 and up ramp 612. The gap 620 keeps the trimmed-off portion from striking against the hard surfaces such as surface 621 during travel. This allows for a minor amount of ‘give’ is terms of alignment between the side surface 607 and the edge of the laminate. Without this give, it would be much more difficult to initiate and continue trimming without interference between the trimmed laminate and the tool. The upper surfaces 610, 612 and 608 of the edge guide may be covered with Teflon or other non-stick material as shown with the hashing to further smooth operation.

Another aspect of the preferred construction is depicted in FIG. 10, which shows the use of an angle α greater than 90 degrees between the lower surface 605 of upper guide 604 and the side 607 of edge guide 606. Just as the ramp 612 and aperture 60 allows for a little twisting motion, the use of an angle greater than 90 degrees allows for a little angular motion, thereby facilitating smooth operation without marking or scoring of the laminate 600. Angles of 91 to 100 degrees are acceptable, more preferably between 93 and 97 degrees.

I claim:

1. For use with a laminate having an exposed front surface and a back surface mounted to a supporting substrate having a peripheral edge, an implement for trimming excess laminate extending beyond the peripheral edge of the substrate, the implement comprising:
an edge guide having a side surface for traveling against the peripheral edge of the substrate;
an upper guide coupled to the edge guide, the upper guide having a lower surface for traveling against the exposed front surface of the laminate;
a handle attached to the coupled guides; and
a blade mounted on the upper guide, the blade having a cutting tip extending below the lower surface of the upper guide and spaced apart from the side surface of the first guide by a distance of two millimeters or less.

2. The implement of claim 1, wherein the side surface includes a leading edge allowing the first guide to travel against the peripheral edge of the substrate before the blade contacts a laminate to be trimmed.

3. The implement of claim 1, wherein the side surface includes a trailing edge allowing the first guide to continue traveling against the peripheral edge of the substrate after the blade trims the mounted laminate.

4. The implement of claim 1, wherein:
the edge guide includes an upper surface; and
the lower surface of the upper guide is spaced apart from the upper surface of the edge guide by a gap to receive laminate to be trimmed.

5. The implement of claim 1, wherein:
the edge guide includes an upper surface;
the lower surface of the upper guide is spaced apart from the upper surface of the edge guide by a gap to receive laminate to be trimmed; and
the gap terminates in an upward ramp on the upper surface of the edge guide.

6. The implement of claim 1, wherein the lower surface of the upper guide includes an aperture between the cutting tip and the back end of the tool.

7. The implement of claim 1, wherein the side surface and the lower surface define an angle greater than ninety degrees.

8. The implement of claim 1, further including a blade holder enabling the blade to be replaceable.

9. The implement of claim 1, further including a mechanism for adjusting the proximity of the blade to the edge guide.
